(19) United States
(12) Patent Application Publication
(10) Pub. No.: US 2014/0104054 A1
(43) Pub. Date: Apr. 17, 2014

(54) BEACON WITH FLASHING AND CONTINUOUSLY ILLUMINATED LEDS

(71) Applicant: CODE 3, INC., St. Louis, MO (US)

(72) Inventor: Craig Weeks, Glendora, CA (US)

(73) Assignee: CODE 3, INC., St. Louis, MO (US)

(21) Appl. No.: 13/651,736

(22) Filed: Oct. 15, 2012

(51) Int. Cl. B60Q 1/26

(52) U.S. Cl. 340/468

(57) ABSTRACT

A beacon configured for mounting on a vehicle having an array of LEDs providing a flashing light signal to observers and having an array of LEDs providing scene illumination to a portion of the vehicle.

### FIELD OF THE INVENTION

The present invention generally relates to flashing light beacons for use on vehicles.

### BACKGROUND OF THE INVENTION

Beacons provide flashing light signals for vehicles such as fire trucks and police cars. In some situations, the vehicles require other types of fixtures to provide continuous lighting of portions of the vehicles.

### SUMMARY OF THE INVENTION

In one example, a beacon for an emergency vehicle comprises a base, first and second arrays, and a processor. The base is configured for mounting on the emergency vehicle. The first array of light emitting diodes (LEDs) is mounted on the base for providing first light signals in a first direction. The second array of LEDs is also mounted on the base for providing second light signals in a second direction different from the first direction. The processor is configured to selectively, intermittently energize the first array of LEDs so that the first light signals comprise a flashing pattern of light warning observers remote from the emergency vehicle. In addition, the processor is configured to continuously energize the second array of LEDs so that the second light signals comprise substantially constant light illuminating an area of the emergency vehicle.

In one example, a vehicle lighting system is provided including an emergency vehicle and a beacon mounted on the emergency vehicle.

In one example, a method is provided for mounting a beacon on an emergency vehicle.

Other objects and features will be in part apparent and in part pointed out hereinafter.

### BRIEF DESCRIPTION OF THE DRAWINGS AND APPENDIX

FIG. 1 is a perspective view of a beacon according to one embodiment of the invention.

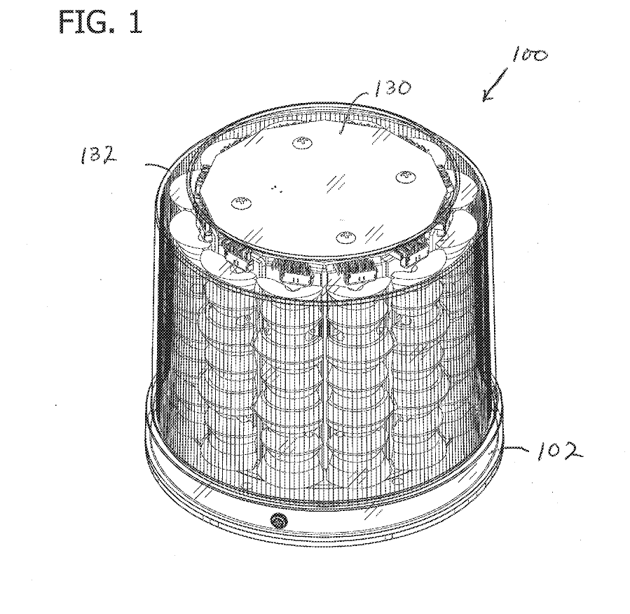

FIG. 2 is a side view of the beacon of FIG. 1.

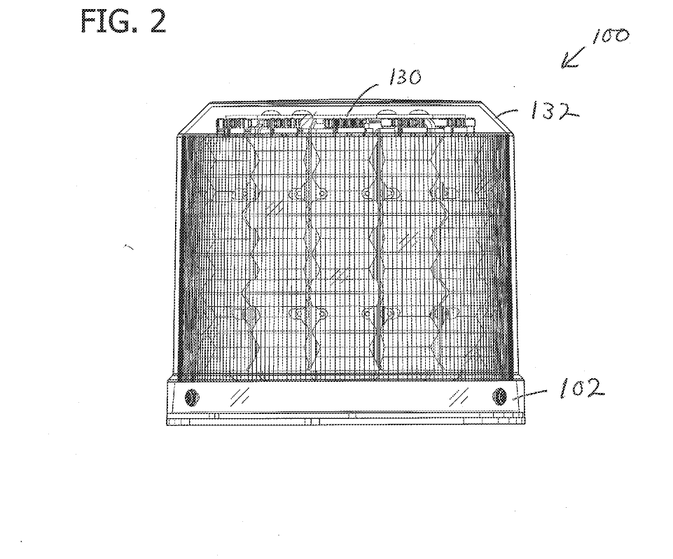

FIG. 3 is a top view of the beacon of FIG. 1.

FIG. 4 is a cross-sectional view taken along lines 4-4 of FIG. 3.

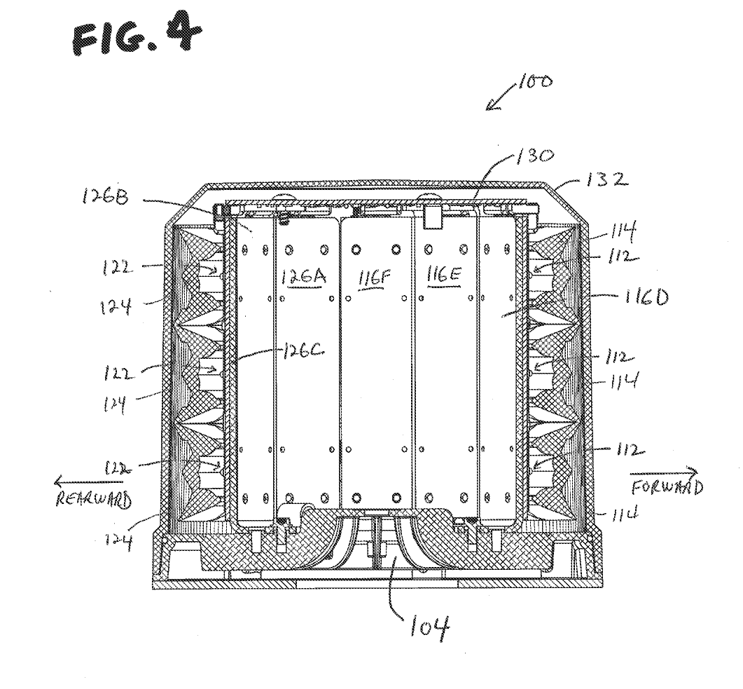

FIG. 5 is a block diagram of a beacon according to one embodiment of the invention.

FIG. 6 is a top view of an emergency vehicle (e.g., a fire truck) having mounted thereon a beacon according to one embodiment of the invention.

The Appendix is an example of an installation and operation manual for a beacon according to one embodiment of the invention.

Corresponding reference characters indicate corresponding parts throughout the drawings.

### DESCRIPTION OF THE PREFERRED EMBODIMENTS

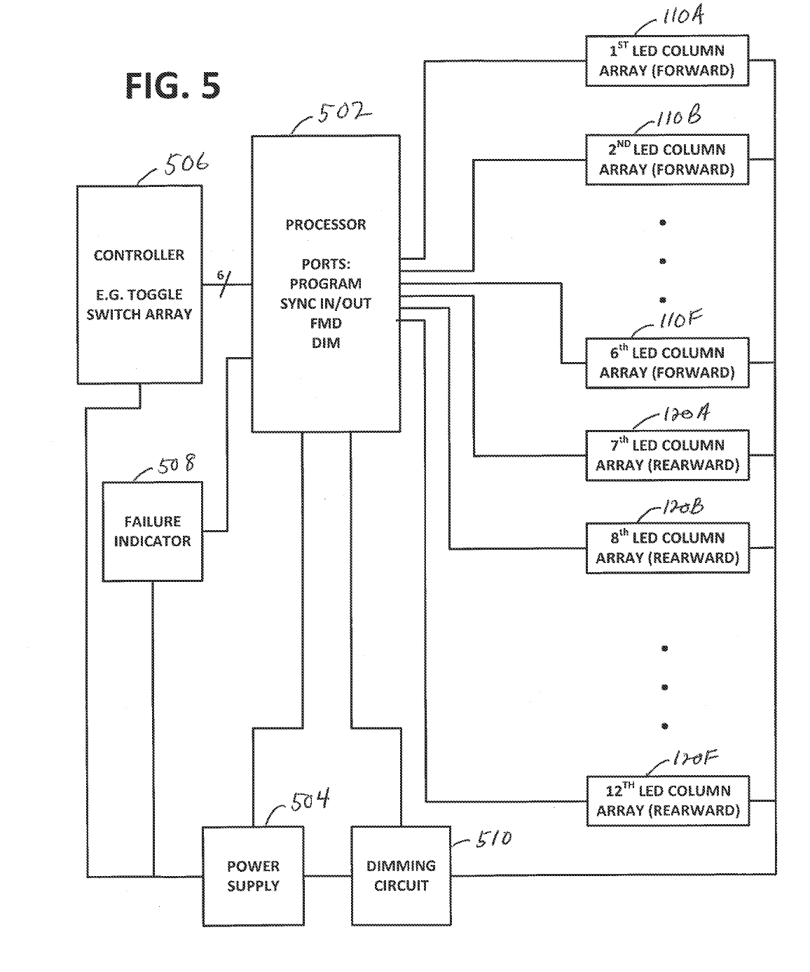

Referring to the figures, a beacon 100 is illustrated for a vehicle such as a vehicle 200 as shown in FIG. 5. The vehicle of FIG. 5 is illustrated as a fire truck. It is contemplated that beacon 100 may be used with any vehicle. For example, any vehicle such as an ambulance, a police vehicle, a fire vehicle, an emergency vehicle, or a maintenance vehicle may use the beacon 100. As another example, any vehicle in which a user desires to have flashing or steady burn, scene lighting may use the beacon 100. Herein, the vehicle 200 may be referred to as a fire truck but it should be understood that vehicle 200 may be any vehicle.

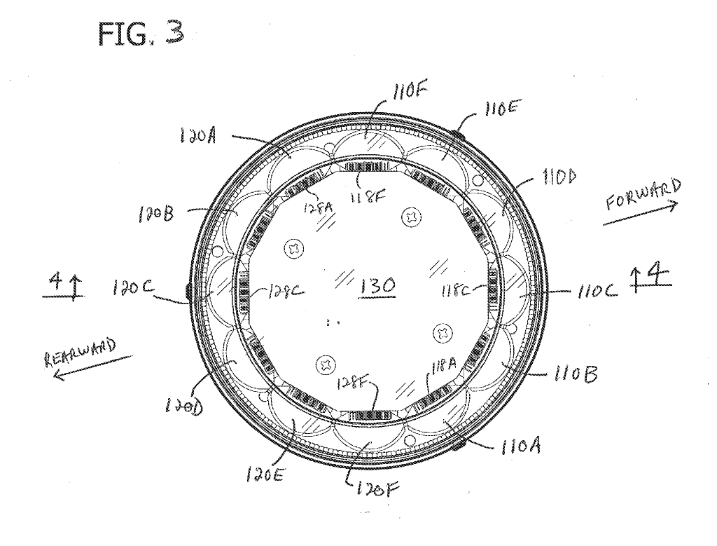

In one example, the beacon 100 comprises a circular base 102 configured for horizontal mounting on the fire truck 200. For example, the base 102 may have a socket 104 for engaging a vertical support post (not shown) of the fire truck 200. The beacon 100 includes a first array 110 of light emitting diodes (LEDs) 112 mounted on the base 102 for providing first light signals in a first direction (e.g., forward). A second array 120 of LEDs 122 is also mounted on the base 102 for providing second light signals in a second direction (e.g., rearward) different from the first direction. Each array 110, 120 comprises a plurality of columns of LEDs 112, 122 covered by a lens 114, 124, respectively. The columns are in a cylindrical configuration as shown in FIG. 3 for providing substantially 360 degrees of horizontal lighting relative to the fire truck 200. Each column is connected to and vertically supported by the base. Each of the LEDs 112, 114 and their associated lenses 114, 124 are mounted to vertical circuit boards 116, 126 which are vertically supported by brackets connected to the base 102. In one example, the lenses 114, 124 collimate the light within a substantially horizontal plane.

The vertical circuit boards 116, 126 are electrically connected to a horizontal, top circuit board 130 via connectors 118, 128 having electrical components mounted to its underside, such as for conditioning various input signals to a processor 502 and/or for conditioning various output signals from the processor 502. Board 130 is supported by brackets and screws and includes various electrical components including the processor 502 and a power supply 504 which is connectable to a power source (not shown) such as a battery of the fire truck 200. A cylindrical lens cover 132 which may be transparent or translucent covers the columns and engages the base 102 to create a water-tight unit.

The processor 502 is configured to selectively, intermittently energize the first array 110 of LEDs 112 so that the first light signals comprise a flashing pattern of light warning observers remote from the fire truck 200. In addition, the processor 502 configured to selectively, continuously energize the second array 120 of LEDs 122 so that the second light signals comprise substantially constant light illuminating an area of the fire truck 200. As illustrated, the beacon 100 includes 12 column arrays, although it is contemplated that any number of two or more LEDs may be included. In one form, the processor 502 may be a flash-based, CMOS microcontroller. However, any processor or controller may be used.

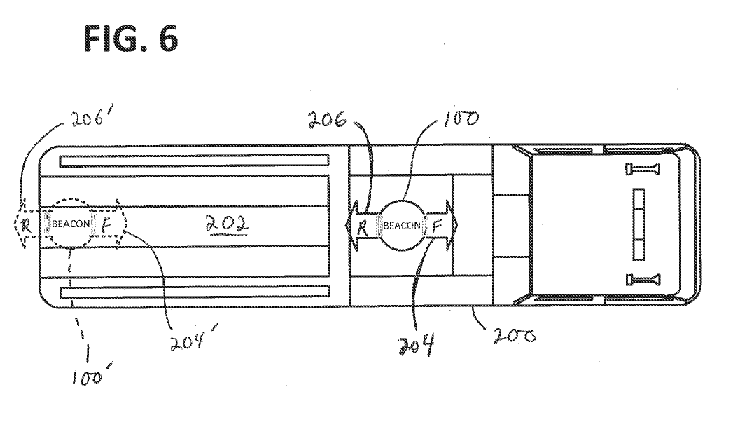

One feature of the beacon 100 is that it is operable in at least one mode in which at least some of the LEDs are continuously illuminated to provide continuous light to an area while other LEDs may be selectively energized to flash and present a flashing signal to observers remote from the beacon 100. For example, as shown in FIG. 6, the fire truck 200 may have a storage compartment such as a hose bed 202. In this example, the beacon 100 is mounted on the fire truck 200 forward of the hose bed 202. As a result, the first array 110 directs its flashing warning light signals in a forward direction 204 away from the hose bed 202 so that a fireman working in or near the hose bed 202 is not distracted by the flashing light signals. As an additional result, the second array 120 directs its continuous light signals in a rearward direction 206 toward the hose bed 202 so that a fireman working in or near the hose bed 202 is provided light to assist the fireman in working.

Forward and rearward are used herein as exemplary. As another example, the beacon 100 may be located at a back end of the fire truck 200 as indicated by phantom beacon 100′. In one example, the beacon 100′ is mounted on the fire truck 200 rearward of the hose bed 202. In this example, the beacon 100 is mounted relative to the truck 200 so that the first array 110 is facing rearward and the second array 120 is facing forward. As a result, the first array 110 directs its flashing warning light signals in a rearward direction 204 away from the hose bed 202 so that a fireman working in or near the hose bed 202 is not distracted by the flashing light signals. As an additional result, the second array 120 directs its continuous light signals in a forward direction 206 toward the hose bed 202 so that a fireman working in or near the hose bed 202 is provided light to assist the fireman in working. In this example, the programming of the beacon 100 is not modified.

Optionally, the programming of the beacon 100 may be modified. For example, the processor 502 may be programmed to accommodate a rearward mount. In this optional configuration, the second array 120 directs flashing warning light signals in a rearward direction 206′ away from the hose bed 202 so that a fireman working in or near the hose bed 202 is not distracted by the flashing light signals. The first array 120 directs continuous light signals in a forward direction 204′ toward the hose bed 202 so that a fireman working in or near the hose bed 202 is provided light to assist the fireman in working. In this optional example, the processor 502 is configured for selectively, intermittently energizing the second array 120 of LEDs 122 so that the second light signals comprise a flashing pattern of light warning observers remote from the fire truck 200. In addition, the processor 502 is configured for selectively, continuously energizing the first array 110 of LEDs 112 so that the first light signals comprise substantially constant light illuminating an area (e.g., hose bed 202) of the fire truck 200.

Optionally, the processor 502 of the beacon 100 may include a mode of operation wherein both the first array 110 and the second array 120 are energized by the processor 502 to provide 360 degrees of emergency warning light signals to warn observers both forward and rearward of the vehicle. For example, in the day time, or at sites where area lighting is available, or while a vehicle is moving, or when a fireman is not working in the hose bed 202, the processor 502 is configured for selectively, intermittently energizing the second array 120 of LEDs 122 so that the second light signals comprise a flashing pattern of light warning observers remote from the fire truck 200 while simultaneously energizing the first array 110 of LEDs 112 so that the first light signals comprise a flashing pattern of light warning observers remote from the fire truck 200.

Optionally, the processor 502 of the beacon 100 may include a mode of operation wherein both the first array 110 and the second array 120 are energized by the processor 502 to provide 360 degrees of continuous lighting to illuminate both forward and rearward of the fire truck 200. For example, in the night time, or at sites where no area lighting is available, or while a vehicle is stationary, or when a fireman is working in the hose bed 202 or around the vehicle 200, the processor 502 is configured for selectively, continuously energizing the first array 110 of LEDs 112 so that the first light signals comprise substantially constant light illuminating an area of the fire truck 200 while simultaneously energizing the second array 120 of LEDs 122 so that the second light signals comprise substantially constant light illuminating an area of the fire truck 200.

It is contemplated that the beacon 100 may be configured to have only one mode of operation. For example, if the beacon is mounted toward the middle of the fire truck 200 as illustrated in FIG. 6, the beacon 100 may be configured to operate in only one mode in which the first array 110 provides flashing warning light signals and the second array 120 is continuously energized to illuminate the hose bed 202. In this example, as noted above, the beacon 100 may be mounted on a rear of a vehicle by rotating its position so that the first array 110 is facing rearward and the second array 120 is facing forward.

For controlling the beacon and it flash patterns, a single selectively grounded wire may be connected to the processor 502 (see the Appendix). In another example, one or more switches as a controller 506 may be connected to the processor 502 for use by an operator to instruct the processor 502 as to its mode of operation. In particular, the controller 506 may have one or more switches for causing the processor 502 to selectively energizes the first array 110 in one or more modes and for causing the processor 502 to selectively energizing the second array 120 in one or more modes independently of the mode in which the first array 110 is energized. Other types of controllers other than switches may be used.

In some scenarios, it may optionally be desirable to dim or reduce the intensity of light output from the second array 120 to reduce the intensity of the flashing light signals. Also, in some scenarios, it may optionally be desirable to dim or reduce the intensity of light output from the first array 110 to reduce the scene lighting. In one example, the processor 502 may be configured to energize the first array and/or the second array in a first power mode and in a second power mode which is less power than the first power mode so that the second power mode is a dim mode compared to the first power mode. As a result, in the second power mode the first array 110 and/or the second array 120 emits a lower intensity of light than emitted in the first power mode. This dim mode may be implemented by an operator using the controller 506. In one example, a dimming circuit 510 between the power supply and the arrays is selectively activated by the processor 502 to reduce power to the arrays 110, 120. Alternatively, the power supply 502 may have several power modes of operation which are controlled by the processor 502 in response to operator input provided by the controller 506. Dimming may be activated by selectively powering a selected port to the processor 502 (see the Appendix).

In one example of a beacon 100, an optional failure indicator 508 is connected to the processor 502, such as via relay device (e.g., any other switching device). The processor 502 is configured to provide a failure mode detect (FMD) function in which the processor 502 monitors a condition (e.g., a ground condition) of the beacon 100. The processor 502 implements a failure indication, such as by energizing and/or de-energizing the failure indicator 508 when the monitored condition is not present, indicative of a failure of the beacon 100. For example, the failure indicator 508 may be an indicator light activated or de-activated when a current, voltage, and/or ground signal of the beacon 100 monitored by the processor 502 is not present and/or outside a given range, and/or in the event the processor 502 is not operating. The indicator may also be an audio generator which is activated when a failure is indicated.

In one example, the processor 502 may be configured to include a sync port input for receiving a sync signal, such as a pulsed signal. The processor 502 would be programmed to selectively, intermittently energize either or both of the arrays 110, 120 so that the light signals are synchronized to the received sync signal. As a specific example, the beacon 100 may be operated in synchronization with another beacon. Optionally, in some configurations, the beacon 100 may be operated in synchronization with a light bar and/or siren on the vehicle.

Alternatively or in addition, the processor 502 may be configured to have a programmable port for receiving a program signal such as a selectively grounded signal. The processor 502 would store a plurality of different patterns and would be responsive to the program signal to selectively, intermittently energize the either or both arrays 110, 120 so that the light signals correspond to the program signal. See the Appendix for additional information regarding flash patterns.

In one example as described herein, a method is provided for mounting a beacon on an emergency vehicle. See the Appendix for additional information regarding mounting.

The Abstract and summary are provided to help the reader quickly ascertain the nature of the technical disclosure. They are submitted with the understanding that they will not be used to interpret or limit the scope or meaning of the claims. The summary is provided to introduce a selection of concepts in simplified form that are further described in the Detailed Description. The summary is not intended to identify key features or essential features of the claimed subject matter, nor is it intended to be used as an aid in determining the claimed subject matter.

For purposes of illustration, programs and other executable program components, such as the operating system, are illustrated herein as discrete blocks. It is recognized, however, that such programs and components reside at various times in different storage components of a computing device, and are executed by a data processor(s) of the device.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well-known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor-executable instructions (e.g., software, firmware, and/or hardware) such as those illustrated herein to implement aspects of the invention.

Embodiments of the invention may be implemented with processor-executable instructions. The processor-executable instructions may be organized into one or more processor-executable components or modules on a tangible processor readable storage medium. Aspects of the invention may be implemented with any number and organization of such components or modules. For example, aspects of the invention are not limited to the specific processor-executable instructions or the specific components or modules illustrated in the figures and described herein. Other embodiments of the invention may include different processor-executable instructions or components having more or less functionality than illustrated and described herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that several advantages of the invention are achieved and other advantageous results attained.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively or in addition, a component may be implemented by several components.

The above description illustrates the invention by way of example and not by way of limitation. This description enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

Having described aspects of the invention in detail, it will be apparent that modifications and variations are possible without departing from the scope of aspects of the invention as defined in the appended claims. It is contemplated that various changes could be made in the above constructions, products, and methods without departing from the scope of aspects of the invention. In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A beacon for a vehicle comprising:
a base configured for mounting on the vehicle;
a first array of light emitting diodes (LEDs) mounted on the base for providing first light signals in a first direction;
a second array of LEDs mounted on the base for providing second light signals in a second direction different from the first direction;
a processor configured for selectively, intermittently energizing the first array of LEDs so that the first light signals comprise a flashing pattern of light warning observers remote from the vehicle; and
said processor configured for selectively, continuously energizing the second array of LEDs so that the second light signals comprise substantially constant light illuminating an area of the vehicle.

2. The beacon of claim 1 wherein the first array comprises a first plurality of columns of LEDs, wherein the second array comprises a second plurality of columns of LEDs, and wherein the first and second plurality of columns are in a cylindrical configuration for providing substantially 360 degrees of horizontal lighting relative to the vehicle.

3. The beacon of claim 1 wherein the vehicle has a storage compartment and wherein the beacon is mounted on the vehicle such that the first array directs its first light signals away from the storage compartment and such that the second array directs its second light signals toward the storage compartment.

4. The beacon of claim 1 further comprising a control connected to the processor for selectively energizing the first array and for selectively energizing the second array independent of energizing the first array.

5. The beacon of claim 1 wherein said processor is configured to energize the first array in a first power mode and in a second power mode which is less power than the first power mode so that the second power mode is a dim mode compared to the first power mode and so that in the second power mode the first array emits a lower intensity of light than emitted in the first power mode.

6. The beacon of claim 1 further comprising a failure indicator connected to the processor, wherein said processor is configured to provide a failure detect indicator mode in which the processor monitors a condition of the beacon and provides the failure indicator when the monitored condition is not present and/or is outside a preset range, indicative of a beacon failure.

7. The beacon of claim 1:
wherein the processor comprises a sync port configured for receiving a sync signal and wherein the processor is configured for selectively, intermittently energizing the first array of LEDs so that the first light signals comprise a flashing pattern of light synchronized to the received sync signal; and
wherein the processor comprises a programmable port configured for receiving a program signal, wherein the processor stores a plurality of different flash patterns and wherein the processor is responsive to the program signal to selectively, intermittently energize the first array of LEDs so that the first light signals comprise a flashing pattern corresponding to the program signal.

8. The beacon of claim 1 wherein in one mode:
said processor is configured for selectively, intermittently energizing the second array of LEDs so that the second light signals comprise a flashing pattern of light warning observers remote from the vehicle; and
said processor is configured for selectively, continuously energizing the first array of LEDs so that the first light signals comprise substantially constant light illuminating an area of the vehicle.

9. The beacon of claim 1 wherein in one mode said processor is configured for selectively, intermittently energizing the second array of LEDs so that the second light signals comprise a flashing pattern of light warning observers remote from the vehicle while simultaneously energizing the first array of LEDs so that the first light signals comprise a flashing pattern of light warning observers remote from the vehicle.

10. The beacon of claim 1 wherein in one mode said processor is configured for selectively, continuously energizing the first array of LEDs so that the first light signals comprise substantially constant light illuminating an area of the vehicle while simultaneously energizing the second array of LEDs so that the second light signals comprise substantially constant light illuminating an area of the vehicle.

11. A vehicle lighting system comprising:
a vehicle;
a base configured for mounting on the vehicle;
a first array of light emitting diodes (LEDs) mounted on the base for providing first light signals in a first direction;
a second array of LEDs mounted on the base for providing second light signals in a second direction different from the first direction;
a processor configured for selectively, intermittently energizing the first array of LEDs so that the first light signals comprise a flashing pattern of light warning observers remote from the vehicle; and
said processor configured for selectively, continuously energizing the second array of LEDs so that the second light signals comprise substantially constant light illuminating an area of the vehicle.

12. The system of claim 11 wherein the first array comprises a first plurality of columns of LEDs, wherein the second array comprises a second plurality of columns of LEDs, and wherein the first and second plurality of columns are in a cylindrical configuration for providing substantially 360 degrees of horizontal lighting relative to the vehicle.

13. The system of claim 12 wherein the vehicle has a storage compartment and wherein the beacon is mounted on the vehicle such that the first array directs its first light signals away from the storage compartment and such that the second array directs its second light signals toward the storage compartment.

14. The system of claim 13 further comprising at least one of:
a control connected to the processor for selectively energizing the first array and for selectively energizing the second array independent of energizing the first array;
a failure indicator connected to the processor, wherein said processor is configured to provide a failure detect indicator mode in which the processor monitors a condition of the beacon and provides the failure indicator when the monitored condition is outside a preset range indicative of a beacon failure;
wherein the processor comprises a sync port configured for receiving a sync signal and wherein the processor is configured for selectively, intermittently energizing the first array of LEDs so that the first light signals comprise a flashing pattern of light synchronized to the received sync signal; and
wherein the processor comprises a programmable port configured for receiving a program signal, wherein the processor stores a plurality of different flash patterns and wherein the processor is responsive to the program signal to selectively, intermittently energize the first array of LEDs so that the first light signals comprise a flashing pattern corresponding to the program signal.

15. The system of claim 14 wherein said processor is configured to energize the first array in a first power mode and in a second power mode which is less power than the first power mode so that the second power mode is a dim mode compared to the first power mode and so that in the second power mode the first array emits a lower intensity of light than emitted in the first power mode.

16. The system of claim 11 wherein said processor is configured to energize the first array in a first power mode and in a second power mode which is less power than the first power mode so that the second power mode is a dim mode compared to the first power mode and so that in the second power mode the first array emits a lower intensity of light than emitted in the first power mode.

17. The system of claim 16 wherein the first array comprises a first plurality of columns of LEDs, wherein the second array comprises a second plurality of columns of LEDs, and wherein the first and second plurality of columns are in a cylindrical configuration for providing substantially 360 degrees of horizontal lighting relative to the vehicle.

18. The system of claim 11 wherein the vehicle has a storage compartment and wherein the beacon is mounted on the vehicle such that the first array directs its first light signals away from the storage compartment and such that the second array directs its second light signals toward the storage compartment.

19. A method for use with a vehicle comprising:
providing a beacon including:
a base configured for mounting on the vehicle;
a first array of light emitting diodes (LEDs) mounted on the base for providing first light signals in a first direction;
a second array of LEDs mounted on the base for providing second light signals in a second direction different from the first direction; and
a processor configured for selectively, intermittently energizing the first array of LEDs so that the first light signals comprise a flashing pattern of light warning observers remote from the vehicle, said processor configured for selectively, continuously energizing the second array of LEDs so that the second light signals comprise substantially constant light illuminating an area of the vehicle; and
mounting the beacon on the vehicle.

20. The method of claim 19 wherein at least one of the following:
wherein said processor is configured to energize the first array in a first power mode and in a second power mode which is less power than the first power mode so that the second power mode is a dim mode compared to the first power mode and so that in the second power mode the first array emits a lower intensity of light than emitted in the first power mode;
wherein a failure indicator is connected to the processor, and wherein said processor is configured to provide a failure detect indicator mode in which the processor monitors a condition of the beacon and provides the failure indicator when the monitored condition is not present and/or is outside a preset range, indicative of a beacon failure;
wherein the processor comprises a sync port configured for receiving a sync signal and wherein the processor is configured for selectively, intermittently energizing the first array of LEDs so that the first light signals comprise a flashing pattern of light synchronized to the received sync signal; and
wherein the processor comprises a programmable port configured for receiving a program signal, wherein the processor stores a plurality of different flash patterns and wherein the processor is responsive to the program signal to selectively, intermittently energize the first array of LEDs so that the first light signals comprise a flashing pattern corresponding to the program signal.
